(19) United States
(12) Patent Application Publication
(10) Pub. No.: US 2015/0324171 A1
(43) Pub. Date: Nov. 12, 2015

(54) ENTROPY SOURCE

(71) Applicant: QUALCOMM Incorporated, San Diego, CA (US)

(72) Inventor: Manfred VON WILLICH, San Diego, CA (US)

(73) Assignee: QUALCOMM Incorporated, San Diego, CA (US)

(21) Appl. No.: 14/275,676

(22) Filed: May 12, 2014

(51) Int. Cl. G06F 7/58; G06F 1/06

(52) U.S. Cl. CPC G06F 7/588; G06F 1/06

(57) ABSTRACT

Disclosed is an apparatus and method for a random number generator. The random number generator may comprise an analog block that includes: a summing analog amplifier; and an integrator coupled the summing analog amplifier, in which, the output of the integrator is fed back to the summing analog amplifier. Further, the random number generator may include: a threshold detector coupled to the integrator; a latch coupled to the threshold detector and a clock, wherein the latch, based upon the output from the threshold detector, outputs a randomized digital bit pattern. The summing analog amplifier adds the randomized digital bit pattern to the fed back output of the integrator. Further, a gain controller may apply a gain to the analog block to vary the time constant of the analog block to ensure sufficient entropy of the outputted randomized digital bit pattern.

### BACKGROUND

1. Field

The present invention relates to an apparatus and method for a random number generator to provide an entropy source.

2. Relevant Background

Random number generators used in silicon circuits that are used for security purposes face difficult challenges. A suitable random number generator should: produce sufficient entropy in its digital output; be reliable over various process, temperature and voltage ranges; be unpredictable to external sources; be non-susceptible to external manipulation (e.g., by attackers); and be amenable to implementation using silicon process technology for systems-on-a-chip (SoC). Presently, one typical embodiment for silicon technology implementation uses a ring oscillator that is sampled on a system clock as an entropy source for use as a random number generator.

Unfortunately, the use of a ring oscillator may fail to be a suitable random number generator for many reasons. For example, the output entropy produced may vary substantially because of the relationship between the ring oscillator frequency and the system clock. In particular, voltage or temperature changes may bring the ring oscillator frequency close to a simple ratio of the sampling clock, resulting in the output entropy being very low. Also, an injected frequency or a local system clock can cause the ring oscillator to mostly phase lock to it, which would result in a predictable signal. This may be a catastrophic failure of entropy that could lead to an attack. Further, ring oscillator's having long-period correlations (i.e., fairly stable frequency and low jitter) imply low entropy. Together, these shortcomings make a ring oscillator an undesirable entropy source for a secure random number generator.

### SUMMARY

Disclosed is an apparatus and method for a random number generator. The random number generator may comprise an analog block that includes: a summing analog amplifier; and an integrator coupled the summing analog amplifier, in which, the output of the integrator is fed back to the summing analog amplifier. Further, the random number generator may include: a threshold detector coupled to the integrator; a latch coupled to the threshold detector and a clock, wherein the latch, based upon the output from the threshold detector, outputs a randomized digital bit pattern. The summing analog amplifier adds the randomized digital bit pattern to the fed back output of the integrator. Further, a gain controller may apply a gain to the analog block to vary the time constant of the analog block to ensure sufficient entropy of the outputted randomized digital bit pattern.

### BRIEF DESCRIPTION OF THE DRAWINGS

FIG. 1 is a diagram of a random number generator circuit, according to one embodiment of the invention.

FIG. 2 is a diagram of an integrator that includes a voltage controlled current source coupled to a capacitor.

FIG. 3 is a chart illustrating a percentage rate of the occurrences of selected bit patterns.

FIG. 4 is a flow diagram illustrating a method for generating an outputted randomized digital bit pattern.

FIG. 5 is a diagram of a computing device in which a random number generator may be utilized.

### DETAILED DESCRIPTION

The word “exemplary” or “example” is used herein to mean “serving as an example, instance, or illustration.” Any aspect or embodiment described herein as “exemplary” or as an “example” in not necessarily to be construed as preferred or advantageous over other aspects or embodiments.

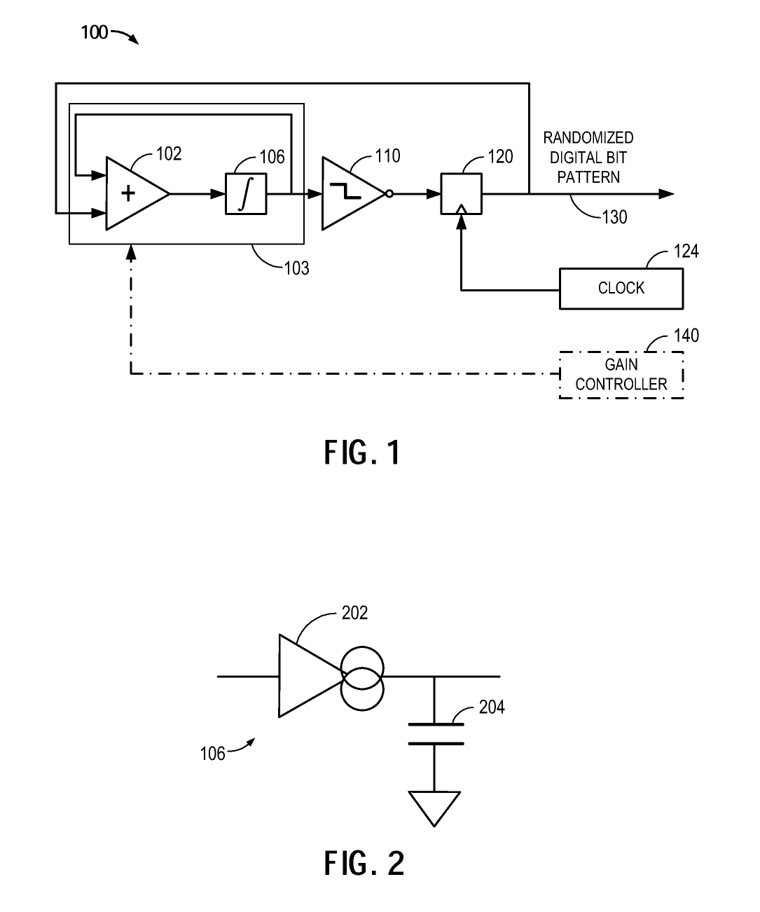

With reference to FIG. 1, a random number generator circuit 100, according to one embodiment of the invention, is shown. The random number generator circuit 100 may include a summing analog amplifier 102 coupled to an integrator 106 that forms an analog block 103. The output of the summing analog amplifier 102 being transmitted to the integrator 106. The output of the integrator 106 may be fed back as an input to the summing analog amplifier 102. Further, a threshold detector 110 is coupled to the integrator 106. The output from the integrator 106 is fed as an input to the threshold detector 110. A latch 120 is coupled to the threshold detector 110 and a clock source 124. The output from the threshold detector 110 is transmitted to the latch 120. The threshold detector 110 (such as an inverting comparator) may be set close to its input range midpoint to output a digital value. Latch 120 may be clocked by clock 124 coupled thereto. The latch 120, based upon the output from the threshold detector 110, may output a randomized digital bit pattern 130. Summing analog amplifier 102 may add the randomized digital bit pattern 130 to the fed back output of the integrator 106. This value is also transmitted as the input to the threshold detector 110. Polarities of each signal may be changed, provided that the overall loop gain polarity in each of the two feedback loops formed is retained.

In one embodiment, a gain controller 140 may optionally be coupled to the analog block 103 (e.g., the summing analog amplifier 102 and/or the integrator 106) and may apply a gain to the analog block 103 to vary the loop gain of the analog block 103 to ensure sufficient entropy of the outputted randomized digital bit pattern 130. Further, in one embodiment, the gain controller 140 through the applied gain may adjust the time constant of the analog block 103 to be long enough to keep output of the integrator 106 from diverging within one clock cycle of the clock 124 from a non-saturating range after a prior cycle of the clock 124 and short enough that the entropy of the outputted randomized digital bit pattern 130 is sufficient.

Further, in one embodiment, as will be described in more detail hereinafter, integrator 106 may be a voltage controlled current source and a capacitor. For example, the voltage controlled current source may be a transistor circuit. In one embodiment, when a gain controller 140 is utilized, the gain controller 140 may be utilized to apply a gain to the voltage controlled current source to vary a time constant to ensure sufficient entropy of the outputted randomized digital bit pattern 130. However, it should be appreciated, that a gain controller 140 does not need to be utilized with every embodiment of the random number generator circuit 100. In some embodiments, the gain controller 140 is not utilized. Further, in one embodiment, the random number generator circuit 100 may be configured for use on a silicon-based system-on-a-chip (SOC). This may be particularly useful when the integrator 106 is a voltage controlled current source that may be implemented as a transistor circuit, with a capacitor.

Therefore, in one embodiment, the random number generator circuit 100 may be considered an entropy source that includes an analog block 103 with a feedback loop that has a single pole, such that its output with zero input is a simple growing exponential voltage, connected to a threshold detector 110 that is sampled on a clock 120 by a latch 120. The sampled binary digital output value (e.g., +/−1) of the threshold detector 110 and the latch 120 (e.g., randomized digital bit pattern 130) is then fed back in such a fashion as to keep the analog system's outputs (i.e., from the summing analog amplifier 102 and integrator 106) within their linear operating range.

In order to aid in the explanation of a random number generator circuit 100, it should be appreciated that random number generator circuit 100 implements a RHP (Right-Hand-Plane-Pole) pass function in which the impulse response is a voltage that grows exponentially with time. In particular, summing analog amplifier 102 and integrator 106 configured with closed loop feedback implement a RHP pass function. However, the RHP pass function is an unstable response, and generally leads to the output saturating (i.e., reaching the highest or lowest value that the integrator 106 can drive) within a short period of time if the input is kept at zero. Even when the output starts with a value that is indistinguishable from zero, any noise in the circuit will result in a divergence from zero with the consequent exponentially growing output. In the random number generator circuit 100 referred to herein, this block of the summing analog amplifier 102 and integrator 106 implementing the RHP pass function may be referred to as the analog block 103.

With the addition of the threshold detector 110 (e.g., implementable as a comparator) and the latch 120, with a constant frequency clock signal from a clock 124 clocking the latch 120, and with the time constant of the analog block 130 being significantly long, provided that the analog output of the analog block 130 (e.g., the RHP pole block) is within a suitable voltage range at the time at which the threshold detector's 110 output is latched and the latch's output (e.g. randomized digital bit pattern 130) is fed back to the input of the summing analog amplifier 102, the random number generator circuit 100 should remain in an unsaturated operating range. This may be arranged based upon a combination of a few factors: that the analog block 103 output will saturate at determined levels (e.g., close to the respective supply rail voltages); that the latches 120 output of the opposite polarity is of sufficient amplitude to cause the output to start in the direction away from the saturation; and that the time constant of the analog block 103 is sufficiently long that the output does not move into an inadequately linear operation region (e.g., by saturation of the output). A further condition that needs to be met for correct operation is that the analog block 103 is designated to operate sufficiently linearly for all possible combinations of input and output voltages that occur during normal operations. “Sufficiently linear” is referred to mean that the rate of change of the output of the analog block 103 is a monotonic function of the input under normal operating conditions. A “monotonic function” is referred to mean that the rate of change function is strictly increasing over the input range of the analog block 103. This means that any difference in the input voltage, no matter how small, should result in a nonzero difference in the rate of change of the output of the correct polarity. Also, it should be appreciated that the threshold detector 110 may be implemented as a comparator.

The time constant (e.g., measured as the exponential doubling time) of the analog block 103 should be less in the period (cycle time) of the clock signal of the clock 124 to the latch 120, with sufficient margin to satisfy linearity requirements. As the time constant increases, the output entropy (e.g., randomized digital bit pattern 130) of the random number generator circuit 100 will be reduced, and thus the time constant should not be made too long. The characteristics of the random number generator circuit 100 should take these factors into account and ensure that the time constant remains within a suitable range.

Entropy generation (e.g., characterized by the randomized digital bit pattern 130) may be understood as follows. Any difference in an initial condition of the analog block 130, or subsequently added noise, may be multiplied by a factor larger than 1 by analog block 130 during each clock cycle by clock 124. The digital sampling process implemented by threshold detector 110 and latch 120 (e.g., outputting +/−1) provides feedback (e.g., randomized digital bit pattern 130) that keeps the random number generator circuit 100 within its operating range, ensuring that this multiplication occurs on every cycle set by clock 124, aside from the discrete adjustment on every cycle. The digital selection (e.g., latched value, +/−1) depends on the previously multiplied value, and this ensures that every latch sample (e.g., each randomized digital bit pattern 130) has fresh entropy (unpredictability), even with perfect knowledge of the history of the output values. The output entropy is less than 1 bit per clock cycle, but even given perfect knowledge of the circuit's behavior and the full history of the output, the most that can be deduced about the subsequent output bit value is the ratio of probabilities of the two possible values. This ratio will depend upon the proceeding bits of the randomized digital bit pattern 130, but will lie within a determinable range of probabilities. The Shannon entropy (in bits) of each output bit bᵢ is −Σᵢ pᵢ log₂ pᵢ, where i takes on the two possible values of the output bit (0 and 1), and the associated pᵢ is the probability associated with that bit value. The two probabilities will satisfy the relation Σᵢ pᵢ=p₀+p₁=1, and the entropy will be zero only if the output bit can be deduced with certainty. With suitable design, the entropy on each bit can be assured to be above a suitable value. This is the basis of the assured entropy output from the circuit. In particular, embodiments of the invention are directed to ensuring sufficient or assured entropy of the outputted randomized digital bit pattern 130.

The implementation of an RHP impulse response may be considered as a single integrator with positive feedback, as illustrated by analog block 103, in FIG. 1. An alternative implementation of an analog block 103 that utilizes a summing analog amplifier with a differential input and a large gain-bandwidth product poses challenges in a context where the gain-bandwidth product is often required to be large, as it would be for clock frequencies of, for example, 100 MHz.

In one embodiment of the invention, the integrator 106 may be a voltage controlled current source, which may be more amenable to implementation in a highly integrated semiconductor circuit. It should be appreciated that the voltage controlled current source may be used in an embodiment in which the gain controller 140 is utilized, or, in an embodiment in which the gain controller 140 is not utilized. With brief additional reference to FIG. 2, an integrator 106 is shown, in which, the integrator is a voltage controlled current source 202 coupled to a capacitor 204. In this example, the voltage controlled current source 202 may be implemented as a transistor circuit. For example, the types of transistors to be used may include bipolar junction transistors (BJT) or metal oxide field effect transistors (MOSFET), which may be used in a configuration in which they act as current sources with moderately linear control, with no need for feedback to realize the voltage controlled current source 202. However, it should be appreciated that any suitable type of transistor may be utilized. When used in such a configuration, their gain-bandwidth product can be high, while their linearity should remain adequate for many different types of implementations. It should be appreciated that by using these types of transistors, when the clock period is short (e.g., 10 ns, corresponding to a frequency of 100 MHz), the current source's maximum output current is low (e.g., 0.01 to 1 mA) and the voltage range is small (e.g., 1 V), as would be typical for highly integrated circuits, in which the required capacitance would be small (in the order of 0.1 to 10 pF, for this example), and thus potentially needing limited silicon area, and further being potentially overlaid on other circuitry in metal and/or polysilicon. In particular, this type of implementation makes the random number generator 110 very configurable for use in a silicon-based system on a chip (SOC).

With reference again to FIG. 1, in one embodiment of the invention, a gain controller 140 may be utilized to account for variations in the random number generator circuit 100. As will be described, the gain controller 140 may apply a gain to the analog block 103 (e.g., the summing analog amplifier 102 and/or integrator 103) to vary the loop gain of the analog block 103 to ensure sufficient entropy of the outputted randomized digital bit pattern 103. As an example, the gain controller 140 may vary a time constant of the analog block 103. In particular, as will be described, the gain of the summing analog amplifier 102 may be controlled and in so doing adjusting the time constant based upon a determination of the frequencies of selected specific bit patterns in the randomized digital bit pattern 103 so that these frequencies remain close to the target values. Thus, instead of allowing the time constant to vary over a range of up to several clock periods due to voltage, temperature and process variations, the feedback can be used to adjust the time constant to the desired value thereby ensuring sufficient entropy. It should be appreciated that the gain controller 140 may be utilized with either a generalized integrator 106, or, with the voltage controlled current source (e.g., transistor circuit and capacitor), as previously described with reference to FIG. 2.

In one embodiment, the random number generator circuit 100 may include an analog block 103 that comprises a summing analog amplifier 102 coupled to an integrator 106 forming the analog block 103 in which the output of the integrator 106 is fed back to the summing analog amplifier 102, as previously described. Further, threshold detector 110 is coupled to integrator 106 and a latch 120 is coupled to threshold detector 110 and is clocked by a clock 124. As previously described, latch 120, based upon the output of the threshold detector 110, outputs a randomize digital pattern 130, in which summing analog amplifier 102 adds the randomized digital bit pattern 130 to the fed-back output of the integrator 106. As an example, in one embodiment, a sampled binary digital output value (e.g., +/−1) of the threshold detector/comparator 110 and the latch 120 (e.g., randomized digital bit pattern 130) is sampled/latched on a per cycle basis based on clock 124, and is fed back in such a fashion as to keep the analog system's output (i.e., from the summing analog amplifier 102 and integrator 106—analog block 103) within its linear operating range. Thus, the output of the digital latch is fed back to the second input of the summing analog amplifier 102 such that the digital feedback may be negative, and marginally larger than the maximum analog feedback. Furthermore, it should be appreciated by those of skill in the art, that a latch may be considered to be any sort of digital circuit that retains data for period of time set by a clock.

Moreover, according to one embodiment of the invention, the gain controller 140 may apply a gain to the analog block 103 (e.g., the summing analog amplifier 102 and/or the integrator 106) to vary the loop gain of the analog block 103 to ensure sufficient entropy of the output of the randomized digital pattern 130.

As previously described, gain controller 140 through the applied gain may adjust the time constant of the analog block 103 to be long enough to keep the output of the analog block 103 from diverging within one clock cycle of the clock 124 from a non-saturating range after a prior cycle of the clock 124 and short enough that the entropy of the outputted randomized digital bit pattern 130 is sufficient. It should be appreciated that a wide variety of various types of permutations of design choices may be utilized to vary the loop gain of the analog block 103 to ensure sufficient entropy of the output of the randomized digital bit pattern.

It should be appreciated that variations in the manufacturing process of the circuitry, voltage, and temperature may affect the operating parameters of the random number generator circuit 100, and in particular, the time constant of the analog block 103, compared to the clock frequency of clock 124. In addition, flexibility in the choice of the frequency of the clock 124 for the latch 120 of the random number generator for the randomized digital bit pattern 130 may be desired. All of these factors may be combined into a need for controlling the time constant of the analog block 103 to keep its operation within a suitable range. Accordingly, aspects of the invention related to the gain controller 140 may provide a mechanism for controlling the time constant to determine whether to increase or decrease the time constant, which may be implemented by controlling the gain of the analog block 103 by the gain controller 140.

In one embodiment of the invention, gain controller 140 applies a gain to the analog block 103 to adjust the time constant of the analog block 103 to be long enough to keep the output of the integrator 106 from diverging within one clock cycle of the clock 124 from a non-saturating range after a prior cycle of the clock 124 and short enough that the entropy of the outputted randomized digital bit pattern 130 is high enough to be sufficient. It should be appreciated that the random number generator circuit 100 may be simulated prior to manufacture to calculate appropriate time constants and gains. For example, during simulation, a gain may be set anywhere in the range of 0 to the gain at which the random number generator circuit 100 may saturate before the next clock tick (i.e., at which operational requirements are violated). In this way, predetermined gains and time constants for use by the random number generator circuit 100 may be predetermined and utilized in operation.

In particular, in one embodiment, the gain controller 140 may apply a gain to the summing analog amplifier 102 and/or the integrator 106 of analog block 103, based upon calculated statistics of the outputted randomized digital bit pattern 130, which are reflective of voltage and temperature variances over time of the circuit characteristics of summing analog amplifier 102 and integrator 106. Gain controller 140 may apply a gain to the analog block 103 (e.g., summing analog amplifier 102 and/or integrator 106) to vary the loop gain of the analog block 103, based upon the detection of predetermined digital patterns of the randomized digital bit output 130. It should be appreciated that the expected occurrence rate of specific patterns in the outputted randomized digital bit pattern 130 may be determined through observation of the simulation and may be utilized in the actual operation of the random number generator circuit 100. Even though the circuit operation of the random number generator circuit 100 is chaotic in nature, the frequency of occurrence in the output of most short bit patterns may be associated with a gain that may then be applied by the gain controller 140. Thus, patterns emerge that can be used by the gain controller 140 to apply a feedback control gain to ensure sufficient entropy of the outputted randomized digital bit pattern 130.

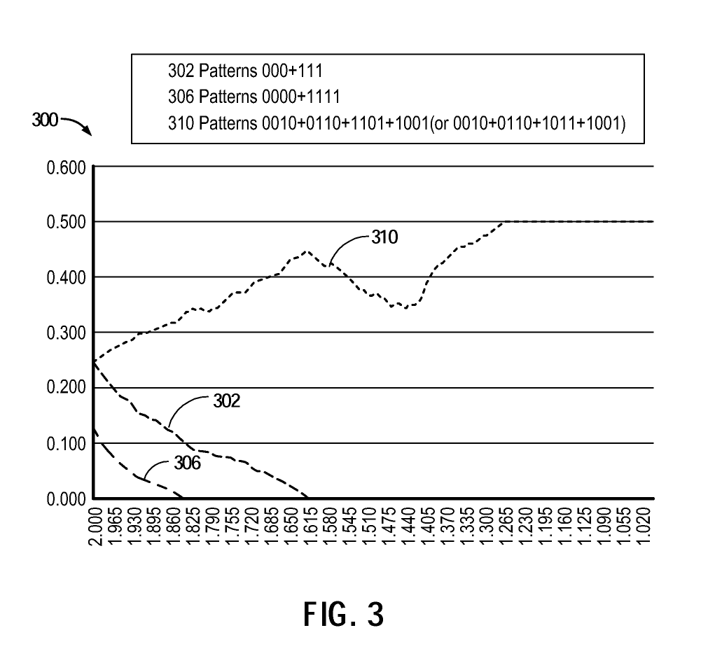

With brief additional reference to FIG. 3, a chart 300 is shown illustrating a percentage rate of the occurrences of patterns (y-axis) vs. the analog output gain factor controlled by the gain controller (x-axis). For example, with reference to line 302, where the occurrence of patterns with 3 successive bits of the same value (i.e., all 0s or all 1s) is shown by line 302, line 302 drops relatively smoothly from 25% when the gain is set so that the analog output doubles every clock cycle to 0% when the analog output goes up by only 1.62 times (or less) every clock cycle, as controlled by the gain controller. Thus, an example of gain control may be slowly and progressively increasing the gain while the patterns are not observed, with a far more substantial reduction in gain (e.g., 100 or 1,000 times as much) when one of these patterns is observed, so that, for example, these patterns are observed with a 1% or even 0.1% frequency.

A similar behavior occurs with patterns of 4 successive equal bits, line 306, except that their occurrence starts at 12.5% when the analog output doubles every clock cycle and drops to 0% when the analog output goes up by only 1.84 times (or less) every clock cycle, as controlled by the gain controller. Where a lower gain is desired (for example, to give wider margins from regions of saturation), other bit patterns may be used to determine whether the gain is reasonable. For example, the occurrence of the bit patterns: 0010, 0110, 1101 and 1001; alternately their reversal; (including overlapping patterns); as shown by line 310, is approximately constant at 50% when the analog output goes up by 1.27 times (or less) every clock cycle, but is lower otherwise. Therefore, the gain of the gain controller 140 may be calculated and applied to the analog block 103 to vary a time constant of the analog block 103 based upon the detection of predetermined amounts of consecutive numbers and/or occurrences of predetermined specific bit patterns in the outputted randomized digital bit patterns to ensure sufficient entropy of the output randomized digital bit pattern 130.

It should be appreciated that the previously described implementation of the random number generator circuit 100 including the use of a gain controller 140 may be utilized with standard integrator 106 or a previously-described specialized integrator that is a voltage control current source 202 and a capacitor 204 (e.g., see FIG. 2), in which the voltage controlled current source may be a transistor circuit. As previously described, this type of implementation may be a very suitable configuration for silicon-based integrated circuitry, such as a system on a chip (SOC).

However, with reference again to FIG. 1, it should be appreciated that embodiments of the invention, as previously described, do not need to utilize the gain controller 140, and can operate without the use of the gain controller 140. In one embodiment, the random number generator circuit 100 may include a summing analog amplifier 102 coupled to an integrator 106 that includes a voltage controlled current source 202 and a capacitor 204, in which the output of the voltage controlled current source 202 is fed back to the summing analog amplifier 102. Further, the random number generator circuit 100 includes a threshold detector 110 coupled to the voltage controlled current source 202 and a latch 120. The latch 120 is coupled to the threshold detector 110 and a clock 124. In this embodiment, the latch 120, based upon the output of the threshold detector 110, outputs a randomized digital bit pattern 130, which is also fed back to the summing analog amplifier 102. The summing analog amplifier 102 adds the randomized digital bit pattern 130 to the fed-back output of the voltage controlled current source 202. This embodiment has been previously described in detail, without the use of a gain controller 140. In this particular implementation example, the summing analog amplifier 102 coupled to the voltage control current source 202 and capacitor 204 may be configured such that the randomized digital bit pattern 130 outputted from the latch 120 always exceeds the output of the voltage controlled current source 202 being fed back to the summing analog amplifier 102, such that, even in a saturated output state from the voltage control current source 202, the output from the latch 120 results in the output from the voltage controlled current source 202 moving away from the saturated output state. It should be appreciated, as previously described in detail, that this type of random number generator circuit 100 utilizing a voltage controlled current source 202 may likewise utilize the gain controller 140, in the same and/or similar fashion, as previously described in detail.

Therefore, as previously described in detail, by utilizing an analog block 103 with a RHP pole to generate entropy in the randomized digital bit pattern 130 of the random number generator circuit 100, unlike other entropy sources, such as ring oscillators, the analog block 103 entropy source may operate robustly to external signal injections, provided that the operation parameters of the random number generator circuit 100 can be kept within reasonable limits, as has been previously described. Further, as previously described, the entropy source generated by the random number generator circuit 100 may be modeled and the entropy rate may be shown to exceed a quantifiable amount if the loop gain is known to fall within a given range. This allows valuable security guarantees to be made about the randomness of the outputted randomized digital bit pattern 130. Further, in one embodiment, a gain controller 140 may be used to apply a gain to summing analog amplifier 102 and/or the integrator 106 to vary the loop gain of the analog block 103 to ensure sufficient entropy of the outputted randomized digital bit pattern 130. In one example, a gain may be applied by the gain controller 140 to the summing analog amplifier 102 to vary a time constant of the analog block. In particular, instead of allowing the time constant to vary over a range of several clock periods due to voltage, temperature, and process variations, the gain controller 140 may be used to adjust the time constant to the desired value thereby ensuring sufficient entropy output for the randomized digital bit pattern 130.

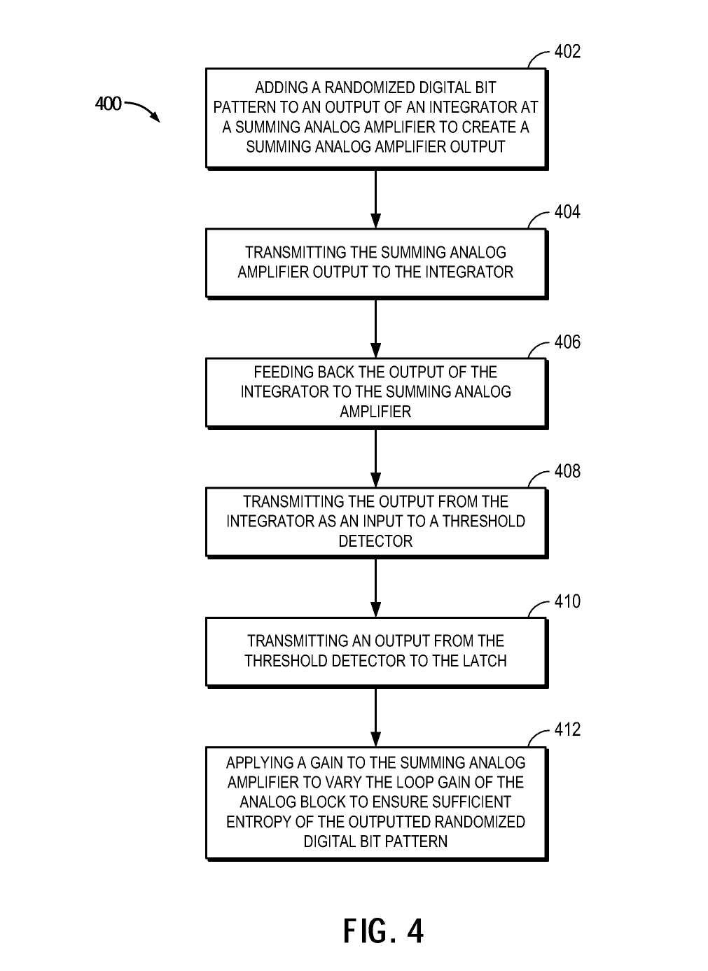

With brief reference FIG. 4, a method for generating an outputted randomized digital bit pattern is disclosed. At block 402, a randomized digital bit pattern is added to an output of an integrator at a summing analog amplifier to create a summing analog amplifier output. At block 404, the summing analog amplifier output is transmitted to the integrator. At block 406, the output of the integrator is fed back to the summing analog amplifier. At block 408 the output from the integrator is transmitted as an input to a threshold detector. At block 410, an output from the threshold detector is transmitted to a latch, wherein, based upon the output from the threshold detector, the latch outputs the randomized digital bit pattern, in which the randomized digital bit pattern is fed back to the summing analog amplifier. At block 412, a gain is applied to the summing analog amplifier to vary the loop gain of the analog block to ensure sufficient entropy of the outputted randomized digital bit pattern.

It should be appreciated that the previously-described random number generator 110 may be utilized with any type of computing device or system.

As used herein, the term “computing device or system” refers to any form of programmable computer device including but not limited to laptop and desktop computers, tablets, smartphones, televisions, home appliances, cellular telephones, personal television devices, personal data assistants (PDAs), palm-top computers, wireless electronic mail receivers, multimedia Internet enabled cellular telephones, Global Positioning System (GPS) receivers, wireless gaming controllers, receivers within vehicles (e.g., automobiles), interactive game devices, notebooks, smartbooks, netbooks, mobile television devices, or any data processing apparatus.

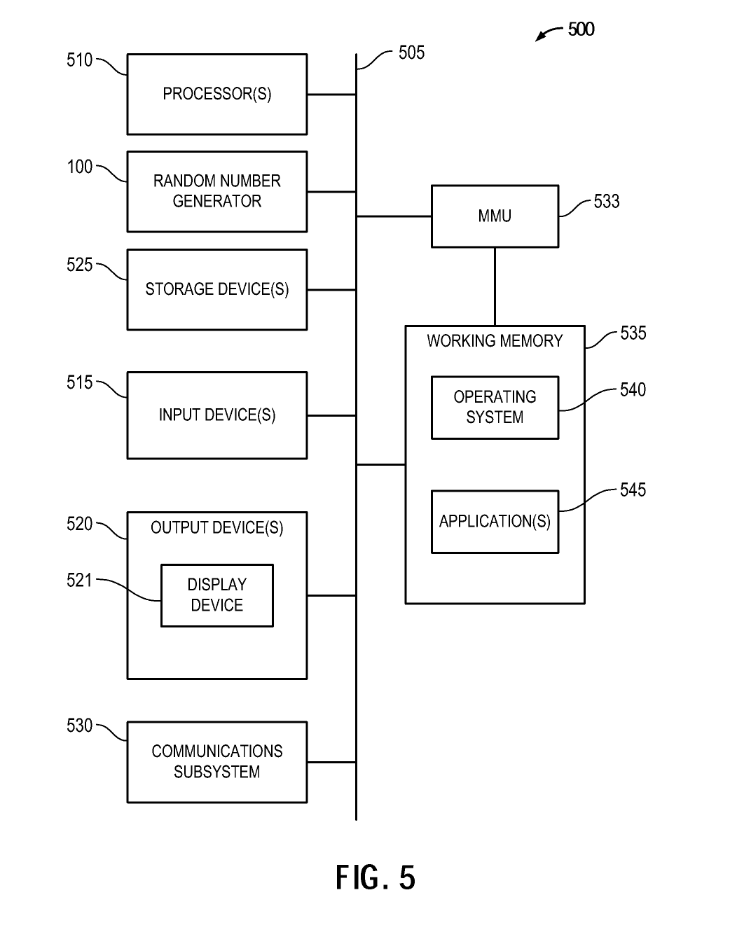

An example computing device 500 that may utilize the previously-described random number generator 110 for the creation of random numbers with sufficient entropy is illustrated in FIG. 5. The computing device 500 is shown comprising hardware elements that can be electrically coupled via a bus 505 (or may otherwise be in communication, as appropriate). The hardware elements may include one or more processors 510, including without limitation one or more general-purpose processors and/or one or more special-purpose processors (such as digital signal processing chips, graphics acceleration processors, and/or the like); one or more input devices 515 (e.g., keyboard, keypad, touchscreen, mouse, etc.); and one or more output devices 520, which include at least a display device 521, and can further include without limitation a speaker, a printer, and/or the like.

The computing device 500 may further include (and/or be in communication with) one or more non-transitory storage devices 525, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable, and/or the like. Such storage devices may be configured to implement any appropriate data stores, including without limitation, various file systems, database structures, and/or the like.

The computing device 500 may also include a communication subsystem 530, which can include without limitation a modem, a network card (wireless or wired), an infrared communication device, a wireless communication device and/or chipset (such as a Bluetooth device, an 802.11 device, a Wi-Fi device, a WiMax device, cellular communication devices, etc.), and/or the like. The communications subsystem 530 may permit data to be exchanged with a network, other computer systems, and/or any other devices described herein. In many embodiments, the computing device 500 will further comprise a working memory 535, which can include a RAM or ROM device, as described above. Further, the computing device 500 may include a system memory management unit (MMU), which is a computer hardware unit that has memory references passed through it, and may be used to perform the translation of virtual memory addresses to physical addresses, in order implement applications. The computing device 500 may also comprise software elements, shown as being currently located within the working memory 535, including an operating system 540, applications 545, device drivers, executable libraries, and/or other code.

Merely by way of example, one or more procedures described with respect to the method(s) discussed previously may be implemented as code and/or instructions executable by a computing device (and/or a processor within a computing device); in an aspect, then, such code and/or instructions can be used to configure and/or adapt a general purpose computer (e.g., a computing device) to perform one or more operations in accordance with the described methods, according to embodiments of the invention. A set of these instructions and/or code might be stored on a non-transitory computer-readable storage medium. In some cases, the storage medium might be incorporated within a computer device, such as computing device 500. In other embodiments, the storage medium might be separate from a computer system (e.g., a removable medium, such as a compact disc), and/or provided in an installation package, such that the storage medium can be used to program, configure, and/or adapt a general purpose computer with the instructions/code stored thereon. These instructions might take the form of executable code, which is executable by the computerized computing device 500 and/or might take the form of source and/or installable code, which, upon compilation and/or installation on the computing device 500 (e.g., using any of a variety of generally available compilers, installation programs, compression/decompression utilities, etc.), then takes the form of executable code.

Random number generator 110 may be utilized by example computing device 500 for the creation of random numbers with sufficient entropy for any functions requested by example computing device 500.

It should be appreciated that aspects of the invention previously described may be implemented in conjunction with the execution of instructions by processors. Particularly, circuitry of the devices, including but not limited to processors, may operate under the control of a program, routine, or the execution of instructions to execute methods or processes in accordance with embodiments of the invention, previously described. For example, such a program may be implemented in firmware or software (e.g. stored in memory and/or other locations) and may be implemented by processors and/or other circuitry of the devices. Further, it should be appreciated that the terms processor, microprocessor, circuitry, controller, etc., refer to any type of logic or circuitry capable of executing logic, commands, instructions, software, firmware, functionality, etc

It should be appreciated that when the devices are mobile or wireless devices that they may communicate via one or more wireless communication links through a wireless network that are based on or otherwise support any suitable wireless communication technology. For example, in some aspects the wireless device and other devices may associate with a network including a wireless network. In some aspects the network may comprise a body area network or a personal area network (e.g., an ultra-wideband network). In some aspects the network may comprise a local area network or a wide area network. A wireless device may support or otherwise use one or more of a variety of wireless communication technologies, protocols, or standards such as, for example, 3G, LTE, Advanced LTE, 4G, CDMA, TDMA, OFDM, OFDMA, WiMAX, and WiFi. Similarly, a wireless device may support or otherwise use one or more of a variety of corresponding modulation or multiplexing schemes. A wireless device may thus include appropriate components (e.g., air interfaces) to establish and communicate via one or more wireless communication links using the above or other wireless communication technologies. For example, a device may comprise a wireless transceiver with associated transmitter and receiver components (e.g., a transmitter and a receiver) that may include various components (e.g., signal generators and signal processors) that facilitate communication over a wireless medium. As is well known, a mobile wireless device may therefore wirelessly communicate with other mobile devices, cell phones, other wired and wireless computers, Internet web-sites, etc.

The teachings herein may be incorporated into (e.g., implemented within or performed by) a variety of apparatuses (e.g., devices). For example, one or more aspects taught herein may be incorporated into a phone (e.g., a cellular phone), a personal data assistant (“PDA”), a tablet, a mobile computer, a laptop computer, an entertainment device (e.g., a music or video device), a headset (e.g., headphones, an earpiece, etc.), a medical device (e.g., a biometric sensor, a heart rate monitor, a pedometer, an EKG device, etc.), a user I/O device, a computer, a wired computer, a fixed computer, a desktop computer, a server, a point-of-sale device, a set-top box, or any other suitable device. These devices may have different power and data requirements

In some aspects a wireless device may comprise an access device (e.g., a Wi-Fi access point) for a communication system. Such an access device may provide, for example, connectivity to another network (e.g., a wide area network such as the Internet or a cellular network) via a wired or wireless communication link. Accordingly, the access device may enable another device (e.g., a WiFi station) to access the other network or some other functionality.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software as a computer program product, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A random number generator comprising:
an analog block including:
a summing analog amplifier; and
an integrator coupled to the summing analog amplifier, the output of the integrator being fed back to the summing analog amplifier;
a threshold detector coupled to the integrator;
a latch coupled to the threshold detector and a clock, wherein the latch, based upon the output from the threshold detector, outputs a randomized digital bit pattern, wherein the summing analog amplifier adds the randomized digital bit pattern to the fed back output of the integrator; and
a gain controller to apply a gain to the analog block to vary a loop gain of the analog block to ensure sufficient entropy of the outputted randomized digital bit pattern.

2. The random number generator of claim 1, wherein, the gain controller through the applied gain adjusts the time constant of the analog block to be long enough to keep the output of the integrator from diverging within one clock cycle of the clock from a non-saturating range after a prior cycle of the clock and short enough that the entropy of the outputted randomized digital bit pattern is high enough to be sufficient.

3. The random number generator of claim 1, wherein, the integrator is a voltage controlled current source and a capacitor.

4. The random number generator of claim 3, wherein, the voltage controlled current source is a transistor circuit.

5. The random number generator of claim 3, wherein, the gain controller applies a gain to the voltage controlled current source to vary a time constant to ensure sufficient entropy of the outputted randomized digital bit pattern.

6. The random number generator of claim 1, wherein, the gain controller applies the gain to the analog block, based upon calculated statistics of the outputted randomized digital bit pattern, reflective of voltage and temperature variations over time of the circuit characteristics of the summing analog amplifier and the integrator.

7. The random number generator of claim 1, wherein, the gain controller applies the gain to the analog block to vary a time constant of the analog block, based upon detection of a predetermined amount of consecutive numbers of the outputted randomized digital bit pattern.

8. The random number generator of claim 1, wherein, the gain controller applies the gain to the analog block to vary a time constant of the analog block, based upon detection occurrences of predetermined specific bit patterns in the outputted randomized digital bit pattern.

9. The random number generator of claim 1, wherein, the random number generator is configured on a silicon-based system-on-a-chip (SOC).

10. A random number generator comprising:
an analog block including:
a summing analog amplifier; and
a voltage controlled current source coupled to a capacitor and coupled to the summing analog amplifier, the output of the voltage controlled current source being fed back to the summing analog amplifier;
a threshold detector coupled to the voltage controlled current source; and
a latch coupled to the threshold detector and a clock, wherein the latch, based upon the output from the threshold detector, outputs a randomized digital bit pattern, wherein the summing analog amplifier adds the randomized digital bit pattern to the fed back output of the voltage controlled current source.

11. The random number generator of claim 10, wherein, the summing analog amplifier coupled to the voltage controlled current source and the capacitor are configured such that the outputted randomized digital pattern outputted from the latch always exceeds the output of the voltage controlled current source being fed back to the summing analog amplifier such that, even in a saturated output state from the voltage controlled current source, the output from the latch results in the output from the voltage controlled current source moving away from the saturated output state.

12. The random number generator of claim 10, wherein, the voltage controlled current source is a transistor circuit.

13. The random number generator of claim 10, further comprising a gain controller to apply a gain to the analog block to vary a time constant of the analog block to ensure sufficient entropy of the outputted randomized digital bit pattern.

14. The random number generator of claim 13, wherein, the gain controller through the applied gain adjusts the time constant of the analog block to be long enough to keep the output of the integrator from diverging within one clock cycle of the clock from a non-saturating range after a prior cycle of the clock and short enough that the entropy of the outputted randomized digital bit pattern is sufficient.

15. The random number generator of claim 13, wherein, the gain controller applies the gain to the analog block, based upon calculated statistics of the outputted randomized digital bit pattern, reflective of voltage and temperature variation over time of the characteristics of the summing analog amplifier, the voltage controlled current source, and the capacitor.

16. The random number generator of claim 13, wherein, the gain controller applies the gain to the analog bock to vary a time constant of the analog block, based upon detection of patterns consisting of a predetermined number of consecutive repeated bits in the outputted randomized digital bit pattern.

17. The random number generator of claim 13, wherein, the gain controller applies the gain to the analog block to vary a time constant of the analog block, based upon detection of a predetermined specific bit pattern of the outputted randomized digital bit pattern.

18. The random number generator of claim 10, wherein, the random number generator is incorporated into a silicon-based system-on-a-chip (SOC).

19. A method comprising:
feeding back and adding a randomized digital bit pattern to an output of an integrator at a summing analog amplifier to create a summing analog amplifier output;
transmitting the summing analog amplifier output to the integrator;
feeding back the output of the integrator to the summing analog amplifier;
transmitting the output from the integrator as an input to a threshold detector;
transmitting an output from the threshold detector to a latch, wherein, based upon the output from the threshold detector, the latch outputs the randomized digital bit pattern, wherein the randomized digital bit pattern is fed back to the summing analog amplifier; and
applying a gain to the summing analog amplifier to vary a loop gain of the summing analog amplifier and the integrator to ensure sufficient entropy of the outputted randomized digital bit pattern.

20. The method of claim 19, further comprising applying a gain to adjust the time constant of a closed loop circuit consisting of the summing analog amplifier and the integrator to be long enough to keep the output of the integrator from diverging within one clock cycle of a clock from a non-saturating range after a prior cycle of the clock and short enough that the entropy of the outputted randomized digital bit pattern is sufficient.

21. The method of claim 19, wherein, the integrator is a voltage controlled current source and a capacitor.

22. The method of claim 21, wherein, the voltage controlled current source is a transistor circuit.

23. The method of claim 21, further comprising applying a gain to the voltage controlled current source to vary a time constant to ensure sufficient entropy of the outputted randomized digital bit pattern.

24. The method of claim 19, further comprising applying the gain to the summing analog amplifier, based upon calculated statistics of the outputted randomized digital bit pattern, reflective of voltage and temperature variations over time of the circuit characteristics of the summing analog amplifier and the integrator.

25. The method of claim 19, further comprising applying the gain to the summing analog amplifier to vary a time constant of the summing analog amplifier, based upon detection of a predetermined amount of consecutive numbers of the outputted randomized digital bit pattern.

26. The method of claim 19, further comprising applying the gain to the summing analog amplifier to vary a time constant of a closed loop circuit consisting of the summing analog amplifier and integrator, based upon detection of predetermined specific bit patterns of the outputted randomized digital bit pattern.

27. A method comprising:
adding a randomized digital bit pattern to an output of a voltage controlled current source coupled to a capacitor at a summing analog amplifier to create an summing analog amplifier output;
transmitting the summing analog amplifier output to the voltage controlled current source;
feeding back the output of the voltage controlled current source to the summing analog amplifier;
transmitting the output from the voltage controlled current source as an input to a threshold detector; and
transmitting an output from the threshold detector to a latch, wherein, based upon the output from the threshold detector, the latch outputs the randomized digital bit pattern, wherein the randomized digital bit pattern is fed back to the summing analog amplifier.

28. The method of claim 27, wherein, the summing analog amplifier coupled to the voltage controlled current source and the capacitor are configured such that the outputted randomized digital pattern outputted from the latch always exceeds the output of the voltage controlled current source being fed back to the summing analog amplifier such that, even in a saturated output state from the voltage controlled current source, the output from the latch results in the output from the voltage controlled current source moving away from the saturated output state.

29. The method of claim 27, wherein, the voltage controlled current source is a transistor circuit.

30. The method of claim 27, further comprising applying a gain to the summing analog amplifier to vary a time constant of a closed loop circuit consisting of the summing analog amplifier and the integrator to ensure sufficient entropy of the outputted randomized digital bit pattern.

31. The method of claim 30, wherein, the gain applied to adjust the time constant of the closed loop circuit consisting of the summing analog amplifier and the integrator is configured to be long enough to keep the output of the integrator from diverging within one clock cycle of a clock from a non-saturating range after a prior cycle of the clock and short enough that the entropy of the outputted randomized digital bit pattern is high enough to be sufficient.

32. The method of claim 30, wherein, the gain applied to the summing analog amplifier, is based upon calculated statistics of the outputted randomized digital bit pattern, reflective of voltage and temperature variations over time of the summing analog amplifier, the voltage controlled current source, and the capacitor.

33. The method 30, wherein, the gain applied to the summing analog amplifier to vary a time constant of the summing analog amplifier, is based upon detection of a predetermined amount of consecutive numbers of the outputted randomized digital bit pattern.

34. The method of claim 30, wherein, the gain applied to the summing analog amplifier to vary a time constant of the closed loop circuit consisting of the summing analog amplifier and the integrator, is based upon detection of a predetermined specific bit pattern of the outputted randomized digital bit pattern.

35. A random number generator comprising:
means for adding a randomized digital bit pattern received from a latch to an output of an integrator to create an output;
means for transmitting the output to the integrator;
means for transmitting the output from the integrator as an input to a threshold detector;
means for transmitting an output from the threshold detector to the latch, wherein, based upon the output from the threshold detector, the latch outputs the randomized digital bit pattern; and
means for applying a gain to vary a time constant to ensure sufficient entropy of the outputted randomized digital bit pattern.

36. The random number generator of claim 35, wherein, the integrator is voltage controlled current source and a capacitor.

37. The random number generator of claim 36, wherein, the voltage controlled current source is a transistor circuit.

38. The random number generator of claim 35, further comprising means for applying the gain to vary a time constant, based upon detection of a predetermined amount of consecutive numbers of the outputted randomized digital bit pattern.

39. The random number generator of claim 35, further comprising means for applying the gain to vary a time constant, based upon detection of a predetermined specific bit pattern of the outputted randomized digital bit pattern.
